(19) United States
(12) Patent Application Publication
(10) Pub. No.: US 2006/0103519 A1
(43) Pub. Date: May 18, 2006

(54) SYE (pronounced sigh) box for safe effective delivery of packages

(76) Inventor: Brian K. Woods SR., Olathe, KS (US)

Correspondence Address: Brian K. Woods Sr., 12524 S Logan St, Olathe, KS, 66061, US

(21) Appl. No.: 10/989,850

(22) Filed: Nov. 15, 2004

(51) Int. Cl. G08B 26/00

(52) U.S. Cl. 340/505

(57) ABSTRACT

A package delivery and storage system designed to protect packages from theft and exposure to the elements. There is also a built in sensor and transmitter that sends a “delivery signal” to a remote receiver alerting the consignee when a package has been delivered.

### REFERENCES CITED

### U.S. Patent Documents

| | | | |
|---|---|---|---|
| 6323782 | Nov. 27, 2001 | Stephens | 340/5.73 |
| 5979750 | Nov. 9, 1999 | Kindell | 232/19 |
| 5444444 | Aug. 22, 1995 | Ross | 340/994 |
| 6483433 | Nov. 19, 2002 | Moskowitz | 340/568.1 |
| 5125570 | Jun. 30, 1992 | Jones | 232/34 |
| 4944422 | Jul. 30, 1990 | Aurness | 220/500 |

### OTHER REFERENCES

Orlando Sentinel, The quest for a Smart Mailbox, May 26, 2001, www.orlandosentinel.com.
EBox Corporate web page, Unattended 24/7 Logistics, www.ebox.com.

### BACKGROUND OF THE INVENTION

1. Field of the Invention

The present invention relates to a SYE Box for the delivery of packages more particularly to a SYE Box that secures packages from theft and exposure to the elements and that provides a delivery notification that a package has been delivered to the SYE Box.

2. Description of the Prior Art

Home delivery of packages has become an increasingly popular way for consumers to reduce shopping time. For example, retailers allow consumers to purchase goods over the phone or online for direct delivery to their homes.

The recent growth of the Internet and televised shopping channels has further accelerated this trend towards home delivery. Major retailers such as Wal-Mart, Amazon.com, and HSN will ship goods directly from their manufacturers and distribution warehouses directly to consumers, by passing the retailer.

Another growing trend that has spawned home delivery is telecommuting and home businesses.

In order for a package to be successfully delivered to a resident, the consignee must either (1) be their to accept and in some cases sign for the delivery, or (2) make arrangements for the package to be delivered to a neighbor.

Some commercial carriers have guidelines in place and have trained their delivery drivers to make deliveries of certain packages to residential customers without them being their in person to accept and sign for the delivery. However, the strict guidelines for these types of deliveries are often not met.

Another problem with home deliveries is that consumers are often not timely notified when a package has been delivered. Leaving packages unattended for extended periods of time, increases the risks of theft or damage.

### OBJECTS AND SUMMARY OF THE INVENTION

In view of the foregoing, it is an object of the present invention to provide an improved SYE Box for safe and effective delivery of packages that encourages consumers to take advantage of the true benefits of home delivery.

It is a more particular object of the present invention to provide a SYE Box that protects delivered packages from theft and or damage.

It is another object of the present invention to provide a SYE Box that provides an “electronic signature” for deliveries requiring a signature at point of delivery.

It is another object of the present invention to provide a SYE Box that provides a “delivery signal” to ensure the consumer is timely notified of a delivery.

In view of these objects and other objects that become evident from the description of the preferred embodiments of the invention herein, an improved SYE Box is disclosed. The SYE Box broadly includes an enclosure for enclosing delivered packages, an address pouch that contains an address card to be used for address validation, an information pouch for updated and specific instructions, an alphanumeric human readable bar-coded signature card for signature required deliveries, an infrared sensor with radio transmitter for transmitting a “delivery signal” to the receiver, a clasp to secure letters and envelops, a locking mechanism that is to be used to secure packages inside of the SYE Box, and a tie-down bar that is used to secure the SYE Box to a permanent fixture.

### BRIEF DESCRIPTION OF THE DRAWING FIGURES

A preferred embodiment of the present invention is described in detail below with reference to the attached drawing figures, wherein:

FIG. 1 is an external perspective view of the SYE Box shown with the retractable knob cover in the closed position;

FIG. 2 is an external perspective view of the SYE Box shown with the retractable knob cover in the open position;

FIG. 3 is an external perspective view of the SYE Box showing the tie-down bar located on the bottom rear of the SYE Box;

FIG. 4 is a diagram of the SYE Box shown with the door opened revealing the intrinsic parts of the SYE Box;

FIG. 5 is an exploded view of the instruction card.

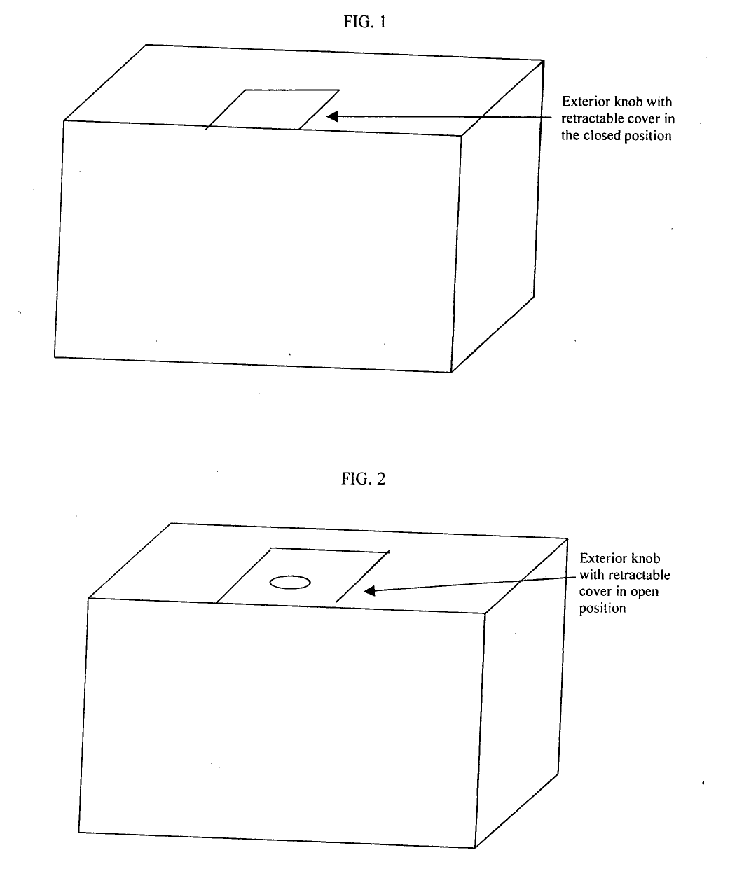

### DETAILED DESCRIPTION OF THE PREFERRED EMBODIMENTS

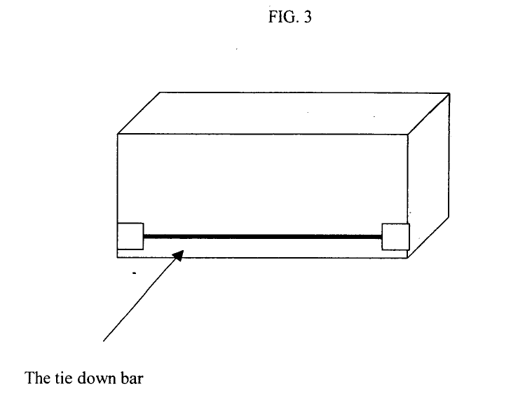

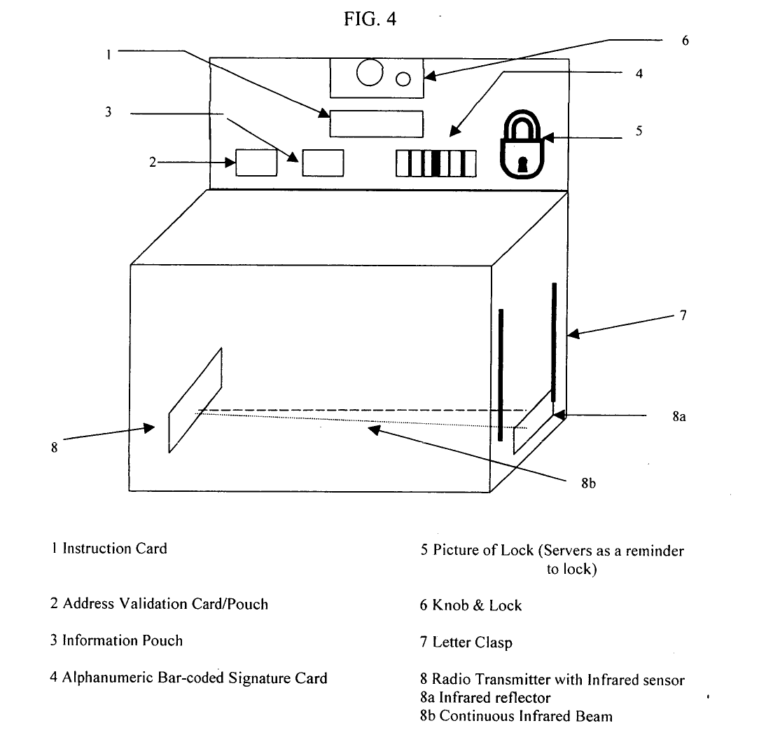

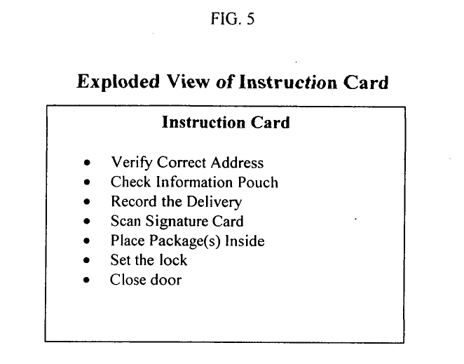

The SYE Box (4) of the present invention may be secured in accordance with the preferred embodiments. FIG. 3 illustrates a tie-down bar that enables one to secure the SYE Box to a permanent fixture. The SYE Box (4) can be attached to the home by using a steel cable and padlock or by using conventional attachment hardware such as bolts or brackets.

The SYE Box may be constructed of any suitable material such as wood, plastic or metal and is preferably approximately 24″ tall, 45-48″ wide, and 21″ deep. The SYE Box exterior may be in different colors and textures that afford the owner the opportunity for personalization.

What I claim is:

1. A package delivery and storage system that protects packages from theft and exposure to the elements.

2. A package delivery and storage system according to claim 1, which has an address validation card and pouch.

3. A package delivery and storage system according to claim 1, that has an information communication pouch.

4. A package delivery and storage system according to claim 1, which has a unique alpha-numeric human readable barcode.

5. A package delivery and storage system according to claim 1, which has an infrared sensor and transmitter as well as a remote receiver.

6. A package delivery and storage system according to claim 1, that contains a letter clasp.

7. A package delivery and storage system according to claim 1, which is equipped with a locking mechanism.

8. A package delivery and storage system according to claim 1, which is equipped with a tie down bar.
